(19) United States
(12) Patent Application Publication
(10) Pub. No.: US 2022/0005038 A1
(43) Pub. Date: Jan. 6, 2022

(54) TRUSTED BENEFICIARY IDENTIFICATION

(71) Applicant: Wells Fargo Bank, N.A., San Francisco, CA (US)

(72) Inventors: Christopher Robert Miller, Brooklin (CA); Lauren Gray Bergsland, Plymouth, MN (US); Kristin K. Koppelman, Bloomington, MN (US); Sridhar Uppaluri, Minneapolis, MN (US); Jeremy Craig Rose, Gresham, OR (US)

(21) Appl. No.: 15/337,122

(22) Filed: Oct. 28, 2016

(51) Int. Cl. G06Q 20/40; G06N 5/04

(52) U.S. Cl. CPC G06Q 20/4014; G06N 5/048

(57) ABSTRACT

Disclosed in some examples are methods, machine readable mediums, and systems that provide for improved payment processing utilizing a trusted beneficiary identification (ID) to identify trusted beneficiaries. The trusted beneficiary ID is included in payment details by the payor and signifies that the beneficiary of the payment is trusted by virtue of a prescreening process and was found to be trustworthy. The trusted beneficiary ID speeds payment by reducing false positives on sanctions checking and also by storing a trusted beneficiary record with beneficiary information which may be utilized to reduce missing or incorrect information.

### TECHNICAL FIELD

Embodiments pertain to improved payment processing systems. Some embodiments relate to utilizing a trusted beneficiary identification to improve payment processing.

### BACKGROUND

Payments sent from one person to another are automatically screened against a sanctions list by computing devices of one or more financial institutions. Sanctions lists are lists of payment beneficiaries, financial institutions, and countries that are prohibited from receiving a payment. Financial entities are legally prohibited from sending payments to entities on these lists. For example, payments may not be allowed to a restricted country, a restricted financial institution, or a restricted beneficiary.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, byway of example, but not byway of limitation, various embodiments discussed in the present document.

FIG. 1 shows a diagram of a payment flow through a financial institution payment processing system according to some examples of the present disclosure.

FIG. 2 shows a diagram of a trusted beneficiary ID manager according to some examples of the present disclosure.

FIG. 3 shows a flowchart of a method of a trusted beneficiary ID manager processing a payment according to some examples of the present disclosure.

FIG. 4 shows a method of revalidating the trusted beneficiaries against an updated sanctions list according to some examples of the present disclosure.

FIG. 5 is a block diagram illustrating an example of a machine upon which one or more embodiments may be implemented.

### DETAILED DESCRIPTION

While these sanction screening processes help prevent payments to undesirables, false positives may happen where innocent beneficiaries are falsely identified as being on one of the many sanctions lists utilized by financial institutions. This may happen when the payor provides incomplete information about the beneficiary, incorrect information about the beneficiary, or when the beneficiary's name matches a different person's name that is on the sanctions list. A false positive may delay payments as additional processing is needed to clear these false positives. This additional processing may involve a manual investigation by a customer service representative. Sometimes this involves asking for additional information from the payor or beneficiary. If the additional information is satisfactory, the customer service representative may manually override the sanctions scan and clear the payment for processing. This introduces substantial additional cost for a financial institution.

Disclosed in some examples are methods, machine readable mediums, and systems that provide for improved payment processing utilizing a trusted beneficiary identification (ID) to identify trusted beneficiaries. The trusted beneficiary ID is included in payment details by the payor and signifies that the beneficiary of the payment is trusted by virtue of a prescreening process and was found to be trustworthy. The trusted beneficiary ID speeds payment processing by automatically clearing false positives on sanctions checking (and in some examples, bypassing sanctions checking altogether) and by supplementing missing or incorrect payee information through use of beneficiary information collected during the prescreening process and stored in a database.

Beneficiaries may register to become trusted beneficiaries by providing certain beneficiary information, such as any one or more of: biographical information (first, middle, and last name, social security number, address, date of birth), financial information (financial institution, account numbers, routing numbers), biometric data (e.g., fingerprints, retinal scan, voice print) and the like. This information may be prescreened and this prescreening process may be accomplished in a variety of ways. For example, the beneficiary information may be automatically vetted against one or more sanctions lists. If the beneficiary information does not match any of the entries in one or more sanctions lists, then the beneficiary may pass the prescreening process and be issued a unique trusted beneficiary ID. If the beneficiary information does match one or more entries in the one or more sanctions lists, then the beneficiary may still pass the prescreening process and be issued a trusted beneficiary ID if additional investigation reveals that the match was a false positive.

In some examples, additional investigation may be done in all instances (whether or not the beneficiary information matches entries on the sanctions lists) prior to issuance of a trusted beneficiary ID. Additional investigation may include background checks, criminal history checks, credit checks, and the like. In some examples, the application may be handled automatically by a computing system. In other examples, the application may be processed manually. In still other examples, the application may be partly processed automatically and partly processed manually.

Once issued, the unique beneficiary ID may be provided to payors by the beneficiary and included by payors in future payment transactions. The use of the identification number will allow the payment to take an expedited route through the sanctions screening process and allow the financial institution processing the payment to supplement or correct any information in the payment. In some examples, the payment processing system may not check the beneficiary against one or more sanctions lists altogether if a valid beneficiary ID is found in the payment information. For example, the payment processing system may only check the beneficiary against some, but not all of the sanctions lists that it would normally check the beneficiary against as a result of finding a valid trusted beneficiary ID. In other examples, the payment processing system may not check the beneficiary against any of the sanctions lists. In other examples, the payment may be scanned against the sanctions lists as a normal payment. In these examples, if the beneficiary information matches an item in one of the sanctions lists, the system may check for a trusted beneficiary ID. If a valid trusted beneficiary ID is found, the payment may be approved without the need to consult further systems (such as operations and customer service).

The beneficiary ID process may periodically or constantly monitor changes in the sanctions list to detect any instances in which a trusted beneficiary is later placed on a sanctions list. Upon receiving a new sanctions list, the old sanctions list may be compared to the new sanctions list and any differences may be determined. Any newly added sanction information may then be compared with the beneficiary information in the trusted beneficiary records of the beneficiary ID system to determine if one of the trusted beneficiaries was added to the sanctions list. If a match is found, the trusted beneficiary may have their trusted beneficiary ID suspended and further processing and checking may be done in order to determine if the trusted beneficiary ID should be revoked or restored.

Checking of beneficiary IDs in payments (as well as monitoring for changes in the sanctions lists) may be part of a financial institution's payment processing, or may be provided by a separate service accessible to multiple financial institutions. In some examples, the beneficiary ID process may be run by one or more government organizations. In some examples, the beneficiary ID process may be associated with (and process transactions with) a single bank, but in other examples, a centralized service may be provided that may provide the beneficiary ID process for multiple banks over a network.

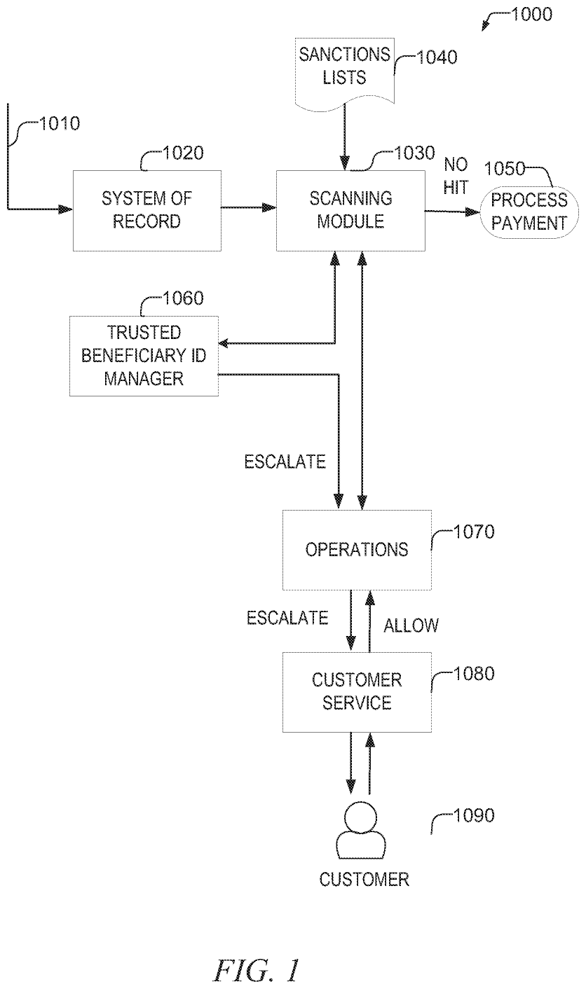

Turning now to FIG. 1 a diagram 1000 of a payment flow through a financial institution payment processing system is shown according to some examples of the present disclosure. A financial institution payment processing system may include one or more discrete computing systems which may be communicatively coupled and which may process one or more payments. In FIG. 1, components of the financial institution payment processing system include a system of record module 1020, scanning module 1030, trusted beneficiary ID manager module 1060, operations module 1070, and customer service module 1080. One of ordinary skill in the art with the benefit of Applicant's disclosure will appreciate that other components or other organizations of components may be used. Modules may be specially designed hardware or hardware which is programmed by one or more instructions to perform the described functions. Modules are explained in more detail below.

Payments in the form of payment information 1010 may be received from one or more payment channels at the system of record module 1020. Payments may be made in many different methods, such as mobile payments, wire payments, online payments, and the like. Different systems may provide payment functionality to allow for these different payment methods. Each of these systems may be connected with one or more payment processing systems, such as the payment processing system from FIG. 1. These systems may provide a “payment channel”—a payment channel is a particular payment type provided by one or more computer systems.

Upon receiving a payment in the form of payment information 1010 from a payment channel, system of record module 1020 may record the payment information 1010 in a database. Payment information 1010 may be in an industry standard format or an internal financial institution format. For example, industry standard formats include formats such as a Federal Reserve Wire Network (Fedwire) format, Automated Clearing House (ACH) format, Society for Worldwide Interbank Financial Telecommunication (SWIFT) format, and the like. In some examples, the system of record module 1020 may convert an internal format to one of the above mentioned formats and send it to one or more clearinghouses for settlement or processing. In some examples, payment information 1010 may be converted to one of the aforementioned formats from a different one of the aforementioned formats or from an internal format of the financial institution payment processing system.

Prior to processing the payment at operation 1050, the system of record module 1020 may pass the payment information 1010 to the scanning module 1030. In some examples, scanning module 1030 may pass the payment information to the trusted beneficiary ID manager module 1060 to determine if the payment information includes a trusted beneficiary ID. Trusted beneficiary ID manager module 1060 may determine if the payment includes a trusted beneficiary ID and if that ID is valid. For example, the trusted beneficiary ID manager module 1060 may determine that the payment information 1010 includes a trusted beneficiary ID corresponding to a trusted beneficiary record in its registration data. In some examples, this may include verifying that the payment information (e.g., beneficiary name and other information) closely matches (e.g., based upon a fuzzy matching algorithm) the beneficiary information in the beneficiary record. This process is described in more detail below.

Trusted beneficiary ID manager module 1060 may also supplement or correct any payment information 1010 based upon the trusted beneficiary record corresponding to the trusted beneficiary ID in the payment information 1010. Trusted beneficiary ID manager module 1060 may indicate to scanning module 1030 if the payment includes a valid trusted beneficiary ID. The scanning module 1030 may bypass comparing the payment information 1010 against one or more of the sanctions lists 1040 (in some examples, all the sanctions lists) if the trusted beneficiary ID manager module 1060 indicates that the payment information 1010 includes a valid trusted beneficiary ID. In these examples, the payment to the trusted beneficiary may shortcut one or more sanctions scans. This may speed up processing of the payment.

If the trusted beneficiary ID manager module 1060 does not indicate that a valid trusted beneficiary ID is included, then the scanning module 1060 may proceed as normal by scanning the payment against one or more sanctions lists 1040. If a match is found during this scanning process, the payment information may be sent to operations module 1070, which may clear the payment or send it to customer service module 1080 if operations module 1070 cannot clear the payment. Payments cleared by operations module 1070 or customer service module 1080 may be processed at 1050.

In other examples, scanning module 1030 may utilize one or more sanctions lists 1040 and scan for matches between payment information 1010 and entries in the sanctions lists 1040 prior to invoking the trusted beneficiary ID manager module 1060 to search for a trusted beneficiary ID. In these examples, the trusted beneficiary ID may be used to clear potential false positives and to supplement or correct payment information 1010. As previously noted, sanctions lists may list information on one or more beneficiaries, financial institutions, and/or countries that are prohibited from receiving or sending funds. For example, a sanctions list may contain the names of one or more suspected terrorists that are not allowed to be beneficiaries. Contents of the sanctions lists may be determined by one or more government agencies.

Example payment information scanned against the sanctions lists 1040 includes beneficiary information, country of origin, destination country, payor, amount, or the like. For example, scanning module 1030 may compare the beneficiary name in the payment information 1010 against a list of prohibited beneficiaries in one or more sanctions lists 1040. As another example, scanning module 1030 may compare a payment destination country against a list of prohibited destination countries in one or more sanctions lists 1040. In the example where the scanning module 1030 checks the payment information 1010 for hits against the sanctions lists 1040 before consulting the trusted beneficiary ID manager module 1060 to determine if a trusted beneficiary ID is included, a hit triggers further operations prior to processing the payment. For example, the scanning module 1030 may consult the trusted beneficiary ID manager module 1060 to determine if a trusted beneficiary ID is included in the payment information 1010 and is valid.

If the trusted beneficiary ID is not included or is not valid, the payment information 1010 may be sent (by either the trusted beneficiary ID manager module 1060, scanning module 1030, or system of record module 1020) to operations module 1070 and/or customer service module 1080. If a valid trusted beneficiary ID is included, then the trusted beneficiary ID manager module 1060 may inform the scanning module 1030 of this, and the scanning module may process the payment at operation 1050. In other examples, even if the trusted beneficiary ID is included and is valid, depending on a strength of the match with the sanctions lists 1040 (e.g., the payment information may match multiple items on sanctions lists 1040 or may match certain items that are not over-ridable by the trusted beneficiary ID system), the payment may still be routed to the operations module 1070 and/or the customer service module 1080.

In examples in which the payment information 1010 is scanned for a trusted beneficiary ID prior to scanning for sanctions, if the payment information 1010 includes a valid trusted beneficiary ID, then the payment information 1010 scanning against one or more (or all) of the sanctions lists 1040 may be bypassed. To the extent the payment information 1010 is not scanned against any of the sanctions lists 1040, the payment may be processed at operation 1050. As already noted this may be done by the system of record module 1020, or may be done by other components of the financial institution payment processing system. If the payment information 1010 is scanned against at least one of the sanctions lists 1040 and no matches are found, the payment may be processed at operation 1050. If the payment information 1010 is scanned against at least one of the sanctions lists 1040 and a match is found, the payment may be escalated to operations module 1070 and/or customer service module 1080. Scanning module 1030 (or trusted beneficiary ID manager module 1060) may also determine if payment information 1010 is incomplete or incorrect.

As noted, trusted beneficiary ID manager module 1060 may check to see if the payment includes a trusted beneficiary ID. For example, by parsing the payment information 1010 according to its format to search for a trusted beneficiary ID. If the trusted beneficiary ID is included in the payment information 1010, the trusted beneficiary ID manager module 1060 may look up the trusted beneficiary record with beneficiary information corresponding to the trusted beneficiary ID.

In some examples, for additional security, the beneficiary information in the payment is compared with the beneficiary information in a trusted beneficiary record using a fuzzy matching algorithm. The trusted beneficiary record is created when a user applies for a trusted beneficiary ID. This information is used in the prescreening process to determine if a trusted beneficiary ID is to be issued to the person. The beneficiary information compared may be one or more beneficiary information fields, such as name, address, phone number, bank information, and the like and may be exclusive of the trusted beneficiary ID itself (as this was already matched). If enough fields match close enough (within a predetermined or configurable degree of certainty), the trusted beneficiary ID manager module 1060 may indicate that the trusted beneficiary ID is valid (which may allow the payment to proceed), otherwise the trusted beneficiary ID is not considered valid and the scanning module 1030 may be notified (and the payment may be treated as if a trusted beneficiary ID was not found). For example, the fuzzy match algorithm may be, for example, an approximate string matching algorithm that judges closeness of a match by the number of operations to convert one input string into the other input string. If the number of operations for all the compared fields is less than a predetermined threshold, then it may be considered a match.

In the case that the payment has missing or incorrect data fields, the trusted beneficiary ID manager module 1060 may fill in or correct missing or wrong information with the corresponding beneficiary information from the trusted beneficiary record (which may be stored electronically in a database). The payment information may have beneficiary information separated into discrete fields (e.g., a name field, an address field, etc.). The corresponding field in the trusted beneficiary record may be used to supplement missing information in the payment information. For example, if the payment information is missing a beneficiary address, the beneficiary address from the trusted beneficiary record may be used to fill in or correct this field in the payment information. In some examples where information in the payment conflicts with information in a data store, the information in the trusted beneficiary record may be considered authoritative.

In some examples, the payment information corrected by the trusted beneficiary ID manager module 1060 as well as an indication that the beneficiary is a trusted beneficiary may be transmitted to the entity that is processing the payment (e.g., the system of record module 1020, or scanning module 1030) or to an external entity (e.g., another financial institution involved in the payment).

If a payment is escalated to an operations module 1070, operations module 1070 may automatically perform data validation, check payment details against lists of frequent false positives and the like in an effort to clear the payment. In some examples, the operations module 1070 may allow a payment automatically based upon one or more business rules. If the operations module 1070 clears the payment, the payment may be processed at operation 1050. If the operations module 1070 fails to automatically allow the payment, operations module 1070 may forward the payment information to customer service module 1080 which may provide one or more graphical user interfaces (GUI) to one or more customer service agents who may contact the customer 1090 (either the beneficiary or the payor) for more information. For example, additional information may allow the customer service personnel to determine that the beneficiary is a different person than the person on the sanctions list. Customer service representatives may then utilize GUIs provided by customer service module 1080 to allow the payment. By short circuiting operations module 1070 and customer service module 1080 by eliminating false positives and missing or incorrect information, the trusted beneficiary ID manager module 1060 using the trusted beneficiary ID may reduce processing time and delays.

The components of FIG. 1, including the system of record module 1020, scanning module 1030, trusted beneficiary ID manager module 1060, operations module 1070 and one or more computer systems that support customer service 1080 may operate on one or more computing systems. Computing systems may be in the same or different institution, and may communicate with each other over one or more networks (e.g., Intranet, Internet, and the like). Additionally, the functional organization of the various modules of FIG. 1 are exemplary and may be re-arranged such that some functionality described as being provided by a certain component may be provided by one or more of the other components. In some examples, the trusted beneficiary ID manager module 1060 may be part of a single financial institution, but in other examples, it may be a network based service available to more than one financial institution. Messages and information exchanged between components may be transmitted across one or more communication links and/or networks and may utilize one or more message protocols.

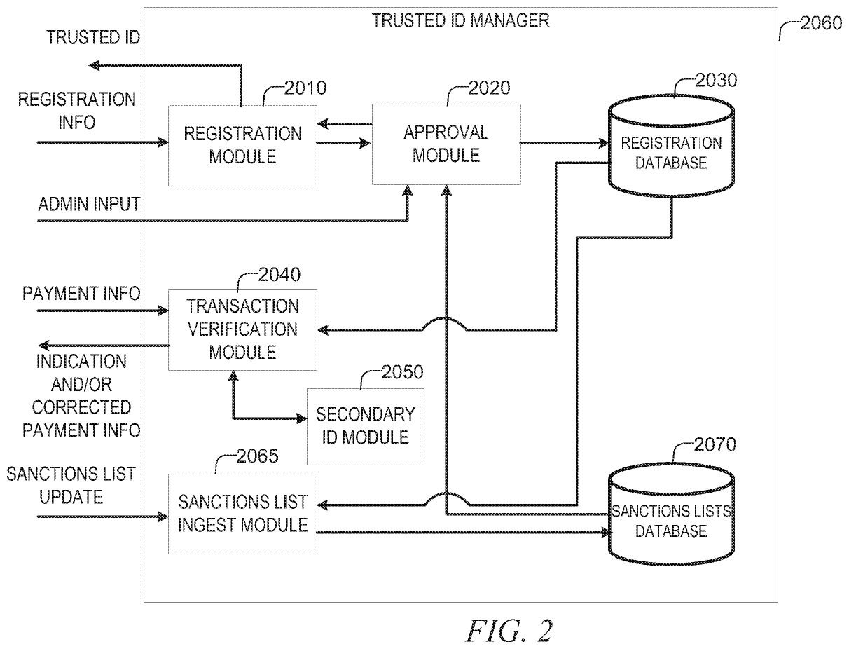

Turning now to FIG. 2, a trusted beneficiary ID manager 2060 is shown according to some examples of the present disclosure. Trusted beneficiary ID manager 2060 may be an example embodiment of trusted beneficiary ID manager module 1060 according to some examples. Registration module 2010 may receive registration information for one or more beneficiaries for registration as a trusted beneficiary and issuance of a trusted beneficiary ID. This registration information may be received through one or more graphical user interfaces (GUIs) provided by one or more modules or services. In some examples, these GUIs may be provided by registration module 2010. In other examples, the GUIs may be provided by external services. Registration module may collect the registration information and pass it to approval module 2020. Registration information may include beneficiary information which may include biographical information (first, middle, and last name, social security number, address, date of birth), financial information (financial institution, account numbers, routing numbers), biometric data (e.g., fingerprints, retinal scan, voice print), and the like. This information (as well as information obtained during the prescreening process) may be stored in registration database 2030 as the trusted beneficiary record.

Approval module 2020 may check the beneficiary information against one or more sanctions lists in sanctions list database 2070. In some examples, if the beneficiary information does not match an item in a sanctions list from the sanctions list database 2070, then the approval module 2020 may automatically issue a trusted beneficiary ID and may store the beneficiary information along with the trusted beneficiary ID as a trusted beneficiary record in the registration database 2030. In some examples the trusted beneficiary ID is a unique identification number—that is, each trusted beneficiary has a unique number. These IDs may be issued sequentially (e.g., the first trusted beneficiary may be issued #1 and the second may be issued #2) or may be issued according to a different algorithm (e.g., a random number may be generated until a unique trusted beneficiary ID is created).

The approval module 2020 and the registration module 2010 may then pass the trusted beneficiary ID back to the beneficiary. In some examples, in addition to checking the beneficiary information against the sanctions list, the approval module 2020 may contact one or more outside services. For example, a background check may be ordered and the issuance of the trusted ID may depend on the beneficiary not being on a sanctions list and passing a background check. In some examples, an administrator of the financial institution or other individual or agency may also need to approve the application prior to issuance of a trusted beneficiary id. Thus approval of a trusted beneficiary may be automatic upon satisfaction of certain pre-determined and automated checks, may be subject to human approval, or may both include human and automated elements.

In some examples, to facilitate human based approval methods and to facilitate the administration of the system, including reviewing and managing beneficiary information, the registration module 2010 or another system may provide one or more GUIs to users and/or administrators of the system.

Sanctions list ingest module 2065 receives updated sanctions lists and stores them in the sanctions lists database 2070. As part of the ingestion process, the sanctions list ingest module 2065 may compare the previous sanctions list with the new list to determine any changes that were made. The sanctions list ingest module 2065 may then compare the changes with trusted beneficiary information in the registration database 2030. If information of a trusted beneficiary matches a newly added or changed entry to the sanctions list, the trusted beneficiary may be flagged and trusted beneficiary privileges may be suspended or revoked. In some examples, this may trigger one or more notifications to an administrator of the financial institution, the trusted beneficiary, or the like. In some examples, this may trigger additional investigation by the financial institution to either reinstate the trusted beneficiary or revoke the trusted beneficiary permanently.

Transaction verification module 2040 may determine if an input transaction includes a valid trusted beneficiary ID. If not, the transaction verification module 2040 may transmit an indication that no valid trusted beneficiary ID was found. If a trusted beneficiary ID is found in the transaction information, the transaction verification module 2040 searches registration database 2030 for a trusted beneficiary record corresponding to the trusted beneficiary ID. In some examples, if a trusted beneficiary ID is found matching the supplied trusted beneficiary ID in the payment information, the registration module 2010 may send back an indication that the transaction should be allowed as a trusted beneficiary ID was found. In some examples, incomplete or missing beneficiary information in the transaction information may be supplemented by beneficiary information in the trusted beneficiary record.

In other examples, for additional security, one or more items of the beneficiary information in the input payment information may be compared with one or more items in the beneficiary information in the trusted beneficiary record to determine if it is a close match. For example, if a name and address are close matches (e.g., using a fuzzy logic algorithm and a confidence threshold). If it is a close match, the registration module 2010 may return that the payment should proceed because the beneficiary is a trusted beneficiary. If it is not a close match, the registration module 2010 may return that a trusted beneficiary ID matching the provided information is not found. This may prevent the fraudulent use of a trusted beneficiary ID (e.g., one beneficiary using the trusted beneficiary ID of another beneficiary).

In some examples, beneficiaries may create one or more secondary trusted beneficiary IDs to distribute to various payors. The use of secondary trusted beneficiary IDs protects against malicious use or disclosure of the trusted beneficiary ID. In these examples, a payment may use a secondary trusted beneficiary ID. The secondary beneficiary ID may be a fixed ID that may be stored with the trusted beneficiary record. When the transaction verification module 2040 searches for trusted beneficiary records, it may also search for a match between the trusted beneficiary ID provided in the transaction and secondary trusted beneficiary IDs in the registration database 2030. In some examples, the format of the secondary trusted beneficiary IDs may be different than the format of the trusted beneficiary IDs such that the transaction verification module 2040 may determine quickly whether it is to search for the trusted beneficiary ID or the secondary trusted beneficiary IDs in the trusted beneficiary records. In yet other examples, the secondary trusted beneficiary IDs may be derivable from the trusted beneficiary IDs such that the transaction verification module may determine the trusted beneficiary ID from the secondary trusted beneficiary ID.

In some examples, the secondary trusted beneficiary IDs may be generated on-demand and may have a limited validity period. For example, a trusted beneficiary may give a payor a secondary trusted beneficiary ID that may be valid for only a certain time period. This time period may be stored with the secondary trusted beneficiary id in the registration database 2030. Any attempt to use this ID outside the validity period may be rejected.

In some examples, beneficiaries or payors may obtain one or more secondary trusted beneficiary IDs through secondary trusted beneficiary ID module 2050. Secondary trusted beneficiary ID module 2050 may create one or more secondary trusted beneficiary IDs. The secondary trusted beneficiary IDs may be derived from the trusted beneficiary ID of the user. In other examples, secondary trusted beneficiary IDs may not depend on or may not be derived from the trusted beneficiary ID of the user. For example, they may be randomly generated or generated according to another algorithm. The secondary trusted beneficiary IDs may be provided through one or more GUIs provided by the secondary trusted beneficiary ID module 2050 (e.g., secondary trusted beneficiary ID module 2050 may include a webserver).

In some examples, secondary trusted beneficiary IDs may be dynamically generated by a computing device of a client (e.g., the beneficiary or the payor). For example, the computing device may be programmed with an algorithm which, when provided a seed value, generates a value that can be used as a secondary trusted beneficiary id. New values are regenerated periodically (e.g., every predetermined period of time). When a new value is generated, the old value is no longer valid. When paying, the payor provides the secondary trusted beneficiary ID generated by the computing device. The computing device may be a general purpose computer with a software program to generate the secondary trusted beneficiary IDs. In other examples, the computing device may be a key fob which generates and displays the secondary trusted beneficiary ID. In these examples, the computing device may coordinate with the secondary trusted beneficiary ID module 2050 to ensure that the computing device is configured (e.g., has the right seed value) to produce valid secondary trusted beneficiary IDs.

The trusted beneficiary ID manager, when receiving a dynamically generated secondary trusted beneficiary ID also knows the seed value and the algorithm and is able to determine the correct value of the secondary trusted beneficiary ID. For example, a trusted beneficiary may provide a payor with access to a GUI provided by the financial institution or other system (perhaps provided by the secondary trusted beneficiary ID module 2050) which may provide one or more generated secondary trusted beneficiary IDs, or which may be utilized to synchronize the seed values between the trusted beneficiary ID manager 2060 and the computing device of the payor. Seed values, or secondary trusted beneficiary IDs may be stored in the trusted beneficiary record in the registration database 2030.

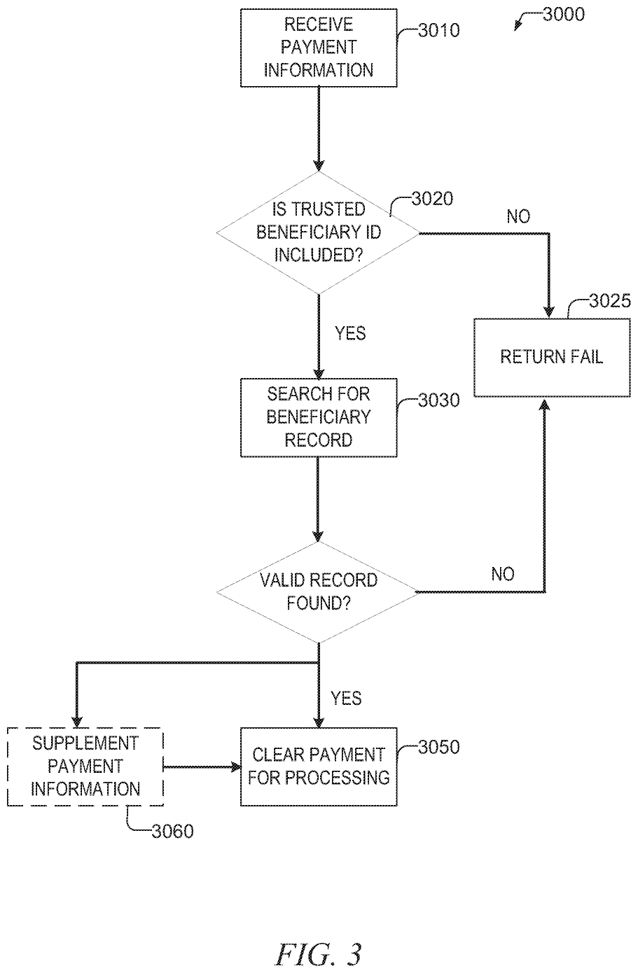

Turning now to FIG. 3 a flowchart of a method 3000 of a trusted beneficiary ID manager (such as trusted beneficiary ID manager 2060 of FIG. 2) processing a payment is shown according to some examples of the present disclosure. At operation 3010 the trusted beneficiary ID manager may receive the payment information. This may be received from the scanning module as a result of a match between payment information and an item on one of the sanctions lists, or may be done prior to scanning for matches between payment information and the sanctions lists. For example, if the method 3000 is performed prior to the sanctions scanning, a positive result from method 3000 may allow the sanctions scanning to be skipped in whole or in part.

At operation 3020 the payment information is checked for a trusted beneficiary ID. If the trusted beneficiary ID is found, then control proceeds to operation 3030. If no trusted beneficiary ID is found, then the trusted beneficiary ID manager may return failure at operation 3025. At operation 3030 the system may search for the beneficiary record corresponding to the trusted beneficiary ID in the payment. If a valid record is not found, then a failure may be returned at operation 3025. If a valid record is found, the payment may be cleared for processing at operation 3050 (e.g., by passing an indication back to the scanning module or system of record that a valid trusted beneficiary was found). In some examples, at operation 3030 the payment information may be compared with the beneficiary information in the located trusted beneficiary record. The comparison may be a fuzzy match applied to one or more of the supplied fields of the payment information with corresponding fields of the beneficiary information from the trusted beneficiary record. The fuzzy match algorithm may be, for example, an approximate string matching algorithm that judges closeness of a match by the number of operations to convert one input string into the other input string. If the number of operations is less than a predetermined threshold, then it may be considered a match.

Optionally, at operation 3060 the system may determine if beneficiary information is missing, incomplete, or incorrect by comparing the beneficiary information in the payment information to the beneficiary information of the trusted beneficiary record. For example, each field of the beneficiary information of the payment information may be compared with each field of the beneficiary information in the trusted beneficiary record. Any differences may be changed to be the information in the trusted beneficiary record. This information may then be passed back to the scanning module or the system of record with the indication that a trusted beneficiary was found at operation 3050.

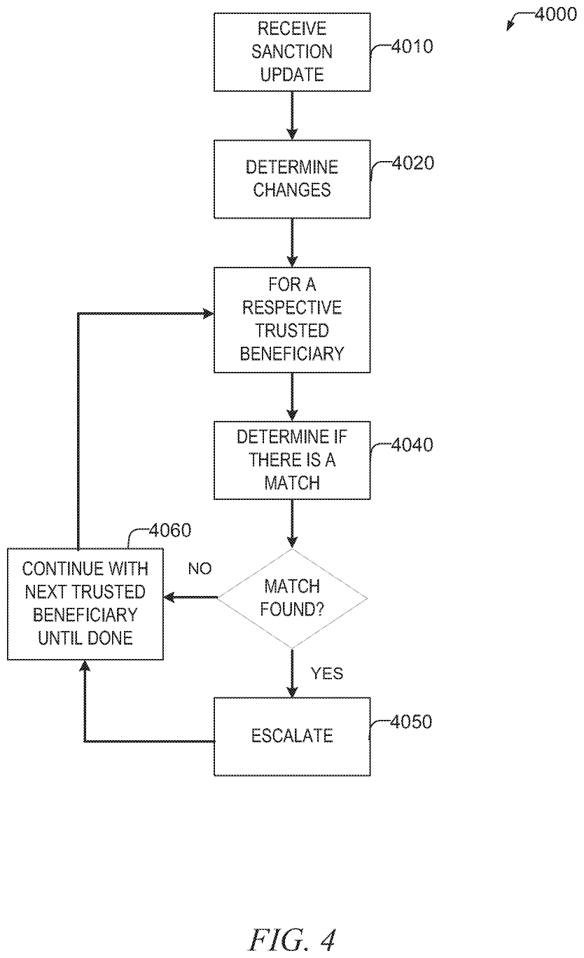

Turning now to FIG. 4, a method 4000 of revalidating the trusted beneficiaries against an updated sanctions list is shown according to some examples of the present disclosure. At operation 4010 the updated sanctions list is received. At operation 4020 the changes between the new list and the updated list are determined. In some examples, the received list at operation 4010 is a list of changes (rather than a new list). In these cases, operation 4020 may not be performed. Operations 4040-4060 are then repeated for each of a set of one or more respective trusted beneficiaries. In some examples, the set may be all of the trusted beneficiaries. In some examples, the set may be less than all of the trusted beneficiaries. At operation 4040 it is determined if there is a match between a newly added sanction and a beneficiary. For example, if a name of a trusted beneficiary matches a newly added name on a sanction list. In another example, if a country of a trusted beneficiary matches a newly added country of a sanction list. At operation 4050, if a match is found the matter may be escalated. For example, the matter may be escalated to another component of a financial institution payment processing system such as operations and/or customer service for review by transmitting one or more messages to that component. In some examples, while this review is ongoing, the trusted beneficiary ID may be suspended (e.g., it will not allow a payment identifying this beneficiary ID to bypass normal sanction scanning). Suspension may be effected by marking the trusted beneficiary ID as suspended in the trusted beneficiary record. The trusted beneficiary ID manager may return that a trusted beneficiary was not found if a trusted beneficiary record is found that indicates that the trusted beneficiary ID is suspended. Either operations or customer service may clear the trusted beneficiary and reinstate the trusted beneficiary ID. At operation 4060, processing may continue with the next trusted beneficiary of the set.

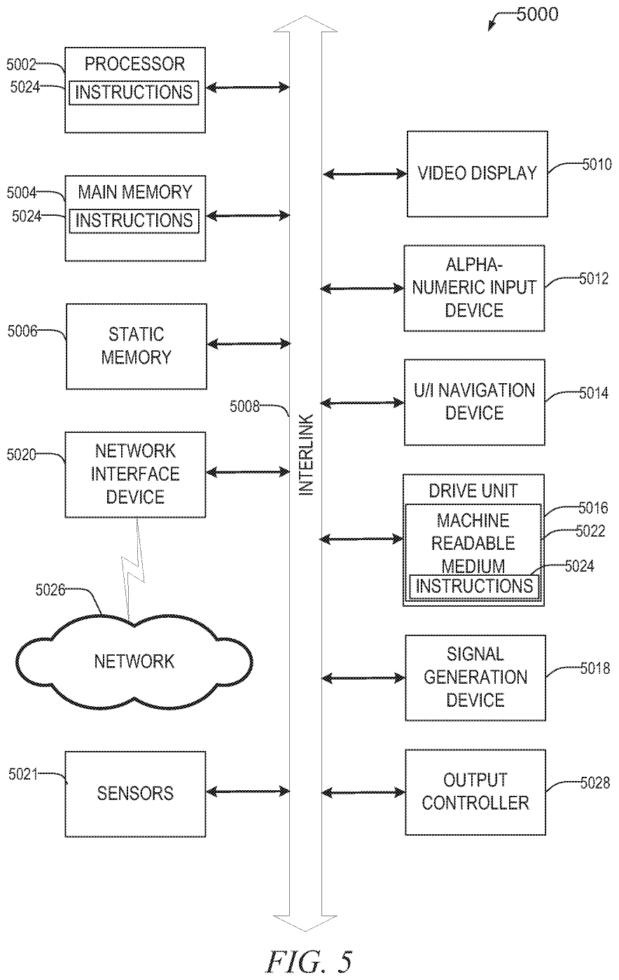

FIG. 5 illustrates a block diagram of an example machine 5000 upon which any one or more of the techniques (e.g., methodologies) discussed herein may perform. In alternative embodiments, the machine 5000 may operate as a standalone device or may be connected (e.g., networked) to other machines. In a networked deployment, the machine 5000 may operate in the capacity of a server machine, a client machine, or both in server-client network environments. In an example, the machine 5000 may act as a peer machine in peer-to-peer (P2P) (or other distributed) network environment. The machine 5000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. For example, machine 5000 may implement any one of the components of FIGS. 1 and 2, and perform any of the methods of FIGS. 3 and 4. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 5000 may include a hardware processor 5002 (e.g., a central processing unit (CPU), a graphics processing unit (GPU), a hardware processor core, or any combination thereof), a main memory 5004 and a static memory 5006, some or all of which may communicate with each other via an interlink (e.g., bus) 5008. The machine 5000 may further include a display unit 5010, an alphanumeric input device 5012 (e.g., a keyboard), and a user interface (UI) navigation device 5014 (e.g., a mouse). In an example, the display unit 5010, input device 5012 and UI navigation device 5014 may be a touch screen display. The machine 5000 may additionally include a storage device (e.g., drive unit) 5016, a signal generation device 5018 (e.g., a speaker), a network interface device 5020, and one or more sensors 5021, such as a global positioning system (GPS) sensor, compass, accelerometer, or other sensor. The machine 5000 may include an output controller 5028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 5016 may include a machine readable medium 5022 on which is stored one or more sets of data structures or instructions 5024 (e.g., software) embodying or utilized by any one or more of the techniques or functions described herein. The instructions 5024 may also reside, completely or at least partially, within the main memory 5004, within static memory 5006, or within the hardware processor 5002 during execution thereof by the machine 5000. In an example, one or any combination of the hardware processor 5002, the main memory 5004, the static memory 5006, or the storage device 5016 may constitute machine readable media.

While the machine readable medium 5022 is illustrated as a single medium, the term “machine readable medium” may include a single medium or multiple media (e.g., a centralized or distributed database, and/or associated caches and servers) configured to store the one or more instructions 5024.

The term “machine readable medium” may include any medium that is capable of storing, encoding, or carrying instructions for execution by the machine 5000 and that cause the machine 5000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 5024 may further be transmitted or received over a communications network 5026 using a transmission medium via the network interface device 5020. The Machine 5000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 5020 may include one or more physical jacks (e.g., Ethernet, coaxial, or phone jacks) or one or more antennas to connect to the communications network 5026. In an example, the network interface device 5020 may include a plurality of antennas to wirelessly communicate using at least one of single-input multiple-output (SIMO), multiple-input multiple-output (MIMO), or multiple-input single-output (MISO) techniques. In some examples, the network interface device 5020 may wirelessly communicate using Multiple User MIMO techniques.

1. A method for processing a transaction using at least one financial institution payment processing system, the method comprising:
using one or more computer processors:
generating a secondary beneficiary ID derived from a trusted beneficiary ID;
registering the secondary beneficiary ID in a registration database with a validity time period;
receiving at the at least one financial institution payment processing system, payment information corresponding to a payment from a payor to a beneficiary;
querying the registration database using the payment information to determine an association between the payment information and the secondary beneficiary ID derived from the trusted beneficiary ID, the trusted beneficiary ID signifying that a trusted beneficiary was prescreened by a previously completed registration process, wherein the trusted beneficiary is prescreened in part by automatically vetting personal data of the trusted beneficiary using a plurality of sanctions lists;
upon determining that the payment information has been received during the validity time period associated with the secondary beneficiary ID from the registration database, determining that the trusted beneficiary ID is valid by:
finding a trusted beneficiary record corresponding to the trusted beneficiary ID;
determining a threshold level of certainty based on the trusted beneficiary ID being valid; and
determining that a fuzzy matching algorithm, applied to at least one field of the trusted beneficiary record that is not the trusted beneficiary ID, matches one field of the payment information, that is not the trusted beneficiary ID, to the determined threshold level of certainty, where the fuzzy matching algorithm is an approximate string matching algorithm that determines a match by a number of operations to convert one input string into another input string; and
wherein during further processing by the at least one financial institution payment processing system, the payment is compared with at least one sanctions list of the plurality of sanctions lists and bypasses comparison with at least one sanctions list of the plurality of sanctions lists that it would have been compared with had the trusted beneficiary ID not been included or determined to be valid.

2. (canceled)

3. The method of claim 1, further comprising:
determining that the payment information is incomplete; and
supplementing the payment information with information from a trusted beneficiary record with a corresponding trusted beneficiary ID.

4. The method of claim 1, further comprising:
determining that at least one item in the payment information is incorrect; and
correcting the at least one item using a corresponding item from a trusted beneficiary record with a corresponding trusted beneficiary ID.

5. The method of claim 1, further comprising:
receiving an update to the at least one sanctions list;
determining changes to the at least one sanctions list based upon the update and the at least one sanctions list;
determining that at least one item of a trusted beneficiary record matches an item added to the at least one sanctions list by the update;
suspending the trusted beneficiary ID; and
transmitting the payment to another component in a financial institution payment processing system.

6. The method of claim 1, wherein the payment information includes a secondary trusted beneficiary ID and wherein determining that the payment information includes the trusted beneficiary ID comprises determining a trusted beneficiary ID from the secondary trusted beneficiary ID.

7. The method of claim 1, further comprising:
receiving second payment information corresponding to a second payment from a second payor to a second beneficiary;
determining that the second payment information does not include a trusted beneficiary ID; and
responsive to determining that the second payment information does not include the trusted beneficiary ID, scanning the payment information against the plurality of sanctions lists.

8. A non-transitory machine-readable medium for causing a machine to process a transaction, the machine-readable comprising instructions, which when performed by the machine, causes the machine to perform operations comprising:
generating a secondary beneficiary ID derived from a trusted beneficiary ID;
registering the secondary beneficiary ID in a registration database with a validity time period;
receiving at at least one financial institution payment processing system, payment information corresponding to a payment from a payor to a beneficiary;
querying the registration database using the payment information to determine an association between the payment information and the secondary beneficiary ID derived from the trusted beneficiary ID, the trusted beneficiary ID signifying that a trusted beneficiary was prescreened by a previously completed registration process, wherein the trusted beneficiary is prescreened in part by automatically vetting personal data of the trusted beneficiary using a plurality of sanctions lists;
upon determining that the payment information has been received during the validity time period associated with the secondary beneficiary ID from the registration database, determining that the trusted beneficiary ID is valid by:
finding a trusted beneficiary record corresponding to the trusted beneficiary ID;
determining a threshold level of certainty based on the trusted beneficiary ID being valid; and
determining that a fuzzy matching algorithm, applied to at least one field of the trusted beneficiary record that is not the trusted beneficiary ID, matches one field of the payment information, that is not the trusted beneficiary ID, to the determined threshold level of certainty, where the fuzzy matching algorithm is an approximate string matching algorithm that determines a match by a number of operations to convert one input string into another input string; and
wherein during further processing by the at least one financial institution payment processing system, the payment is compared with at least one sanctions list of the plurality of sanctions lists and bypasses comparison with at least one sanctions list of a plurality of sanctions lists that it would have been compared with had the trusted beneficiary ID not been included or determined to be valid.

9. (canceled)

10. The machine-readable medium of claim 8, wherein the operations further comprise:
determining that the payment information is incomplete; and
supplementing the payment information with information from a trusted beneficiary record with a corresponding trusted beneficiary ID.

11. (canceled)

12. The machine-readable medium of claim 8, wherein the operations further comprise:
receiving an update to the at least one sanctions list;
determining changes to the at least one sanctions list based upon the update and the at least one sanctions list;
determining that at least one item of a trusted beneficiary record matches an item added to the at least one sanctions list by the update;
suspending the trusted beneficiary ID; and
transmitting the payment to another component in a financial institution payment processing system.

13. The machine-readable medium of claim 8, wherein the payment information includes a secondary trusted beneficiary ID and wherein the operations of determining that the payment information includes the trusted beneficiary ID comprises the operations of determining a trusted beneficiary ID from the secondary trusted beneficiary ID.

14. The machine-readable medium of claim 8, wherein the operations further comprise:
receiving second payment information corresponding to a second payment from a second payor to a second beneficiary;
determining that the second payment information does not include a trusted beneficiary ID; and
responsive to determining that the second payment information does not include the trusted beneficiary ID, scanning the payment information against the plurality of sanctions lists.

15. A system for processing a transaction using at least one financial institution payment processing system, the system comprising:
a processor;
a memory communicatively coupled to the processor and comprising instructions, which when performed by the processor, causes the system to perform operations comprising:
generating a secondary beneficiary ID derived from a trusted beneficiary ID;
registering the secondary beneficiary ID in a registration database with a validity time period;
receiving at the at least one financial institution payment processing system, payment information corresponding to a payment from a payor to a beneficiary;
querying the registration database using the payment information to determine an association between the payment information and the secondary beneficiary ID derived from the trusted beneficiary ID, the trusted beneficiary ID signifying that a trusted beneficiary was prescreened by a previously completed registration process, wherein the trusted beneficiary is prescreened in part by automatically vetting personal data of the trusted beneficiary using a plurality of sanctions lists;
upon determining that the payment information has been received during the validity time period associated with the secondary beneficiary ID from the registration database, determining that the trusted beneficiary ID is valid by:
finding a trusted beneficiary record corresponding to the trusted beneficiary ID;
determining a threshold level of certainty based on the trusted beneficiary ID being valid; and
determining that a fuzzy matching algorithm, applied to at least one field of the trusted beneficiary record that is not the trusted beneficiary ID, matches one field of the payment information, that is not the trusted beneficiary ID, to the determined threshold level of certainty, where the fuzzy matching algorithm is an approximate string matching algorithm that determines a match by a number of operations to convert one input string into another input string; and
wherein during further processing by the at least one financial institution payment processing system, the payment is compared with at least one sanctions list of the plurality of sanctions lists and bypasses comparison with at least one sanctions list of a plurality of sanctions lists that it would have been compared with had the trusted beneficiary ID not been included or determined to be valid.

16. (canceled)

17. The system of claim 15, wherein the operations further comprise:
determining that the payment information is incomplete; and
supplementing the payment information with information from a trusted beneficiary record with a corresponding trusted beneficiary ID.

18. The system of claim 15, wherein the operations further comprise:
determining that at least one item in the payment information is incorrect; and
correcting the at least one item using a corresponding item from a trusted beneficiary record with a corresponding trusted beneficiary ID.

19. The system of claim 15, wherein the operations further comprise:
receiving an update to the at least one sanctions list;
determining changes to the at least one sanctions list based upon the update and the at least one sanctions list;
determining that at least one item of a trusted beneficiary record matches an item added to the at least one sanctions list by the update;
suspending the trusted beneficiary ID; and
transmitting the payment to another component in a financial institution payment processing system.

20. The system of claim 15, wherein the payment information includes a secondary trusted beneficiary ID and wherein the operations of determining that the payment information includes the trusted beneficiary ID comprises the operations of determining a trusted beneficiary ID from the secondary trusted beneficiary ID.

21. The system of claim 15, wherein the operations further comprise:
receiving second payment information corresponding to a second payment from a second payor to a second beneficiary;
determining that the second payment information does not include a trusted beneficiary ID; and
responsive to determining that the second payment information does not include the trusted beneficiary ID, scanning the payment information against the plurality of sanctions lists.

22. The method of claim 1, wherein the fuzzy match algorithm determines a match based on a number of operations to convert a first input parameter string to a second input parameter string, and wherein the first input parameter string is and the second input parameter string is at least one field of the trusted beneficiary record and the second input parameter string is the at least one field of payment information.
